(19) United States
(12) Patent Application Publication
(10) Pub. No.: US 2014/0124046 A1
(43) Pub. Date: May 8, 2014

(54) BALANCE CONTROL VALVE WITH IMPROVED OPERATIONAL SENSITIVITY

(71) Applicant: Ping-Jung TUNG, Taichung City (TW)

(72) Inventor: Ping-Jung TUNG, Taichung City (TW)

(73) Assignees: PAIJO CO., LTD., Changhua City (TW); Ping-Jung TUNG, Taichung City (TW)

(21) Appl. No.: 14/152,456

(22) Filed: Jan. 10, 2014

Related U.S. Application Data
(63) Continuation-in-part of application No. 13/269,789, filed on Oct. 10, 2011.

(51) Int. Cl. F16K 17/38

(52) U.S. Cl. CPC F16K 17/38
USPC 137/98

(57) ABSTRACT

A balance control valve with improved operational sensitivity is accommodated in the holding space preset into the dual-temperature ceramic valve. Annular grooves are located correspondingly to the cold water opening and hot water opening of the fixed valve pipe. An unscaling portion is formed between the annular grooves and the inner wall of the fixed valve pipe in a vertical configuration, and is used to remove scale generated on the exterior of the moveable spool. The setting width of the annular groove is equal to or greater than the width of the cold water opening and hot water opening. With the setting of the annular groove, the contact area of the moveable spool and the inner wall of the fixed valve pipe could be reduced so as to improve the operational sensitivity of the moveable spool, remove the scale and extend the service life of the balance control valve.

### CROSS-REFERENCE TO RELATED U.S. APPLICATIONS

The present application is a continuation-in-part of U.S. patent application Ser. No. 13/269,789, filed on Oct. 10, 2011, and entitled “Balance Valve with Improved Operational Sensitivity”, presently pending.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a balance valve for cold and hot water regulation, and more particularly to an innovative spatial design of the balance control valve with improved operational sensitivity.

2. Description of Related Art Including Information Disclosed Under 37 CFR 1.97 and 37 CFR 1.98.

Given the fact that conventional dual-temperature ceramic valves may lead to transient overburning and scalding due to manual error in turning the faucet and the difficulty in regulating water temperature due to unstable water pressure, an improved structure of dual-temperature ceramic valve combined with cold-hot water balance valve (hereinafter referred to as a balance valve) has thus been developed in this industry.

In spite of currently available ceramic products and relevant patents based on the balance valve, some shortcomings and disadvantages still exist.

A conventional balance valve generally comprises a fixed valve pipe and moveable spool, of which a through-hole is set separately at both ends of the fixed valve pipe, and an opening arranged separately at its both sides so as to guide cold and hot water. An inner groove is formed separately at both ends of the moveable spool, and separated by a partition. Moreover, these two inner grooves are provided with an opening connected with that of the fixed valve pipe. With this structure, when cold, hot water separately pass through two inner grooves of the moveable spool via the openings at both sides of the fixed valve pipe, the moveable spool will yield reciprocating transverse movement with the variation of cold/hot water streams' flow velocity, based on the principle of higher velocity versus smaller pressure and smaller velocity versus bigger pressure as well as the property of water flow. This will change the sectional connection area between the moveable spool and the openings at both sides of the fixed valve pipe, serving the purpose of auto balancing of cold/hot water temperature.

The following shortcomings of typical balance valve are found during actual applications:

First, since the moveable spool is kept in contact with the fixed valve pipe of conventional balance valve in an elongated cylindrical wall, the sensitivity will be reduced due to excessively big frictional coefficient during shift of the moveable spool.

Second, if the balance valve is immersed in water for a longer period of time, scaling may occur gradually on the wall of the fixed valve pipe and moveable spool. In such a case, the small gap preset between the moveable spool and fixed valve pipe will be filled up by the scale, leading to unsmooth operation of the moveable spool, or even loss of movability and water temperature regulation functions.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

With the setting of said annular groove, the contact area of the moveable spool and the inner wall of the fixed valve pipe could be reduced so as to improve the operational sensitivity of the moveable spool.

With the technical characteristics of said unsealing portion formed between said annular groove and inner wall of the fixed valve pipe, the vertical configuration of the unscaling portion could be used to remove scale on the exterior of the moveable spool, thus realizing the effect of maintaining the smoothness of the moveable spool to extend the service life of the balance control valve.

A capillary rough edge formed internally on the openings of the fixed valve pipe will be accommodated into said annular groove, such that the operation of the moveable spool is immune to the influence of the rough edge.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an assembled sectional view of a preferred embodiment of the present invention.

FIG. 2 is a partial exploded perspective view of a preferred embodiment of the present invention.

FIG. 3 is a structural sectional view of the fixed valve pipe of the present invention.

FIG. 4 is a sectional view of the present invention along the X-X direction of the fixed valve pipe.

FIG. 5 is a sectional view of a preferred embodiment of the fixed valve pipe of the present invention.

FIG. 6 is a sectional view of the present invention showing water flow state of the balance control valve with improved operational sensitivity.

FIG. 7 is a schematic view of the present invention wherein the rough edge of the fixed valve pipe could be accommodated into the annular groove.

FIG. 8 is an operating view of the present invention wherein the unscaling portion of the fixed valve pipe could remove scale.

### DETAILED DESCRIPTION OF THE INVENTION

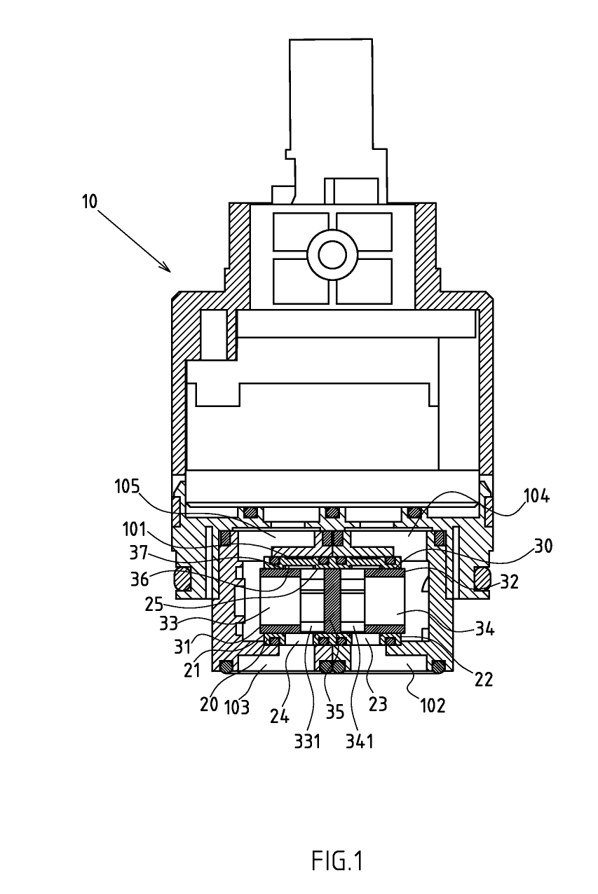

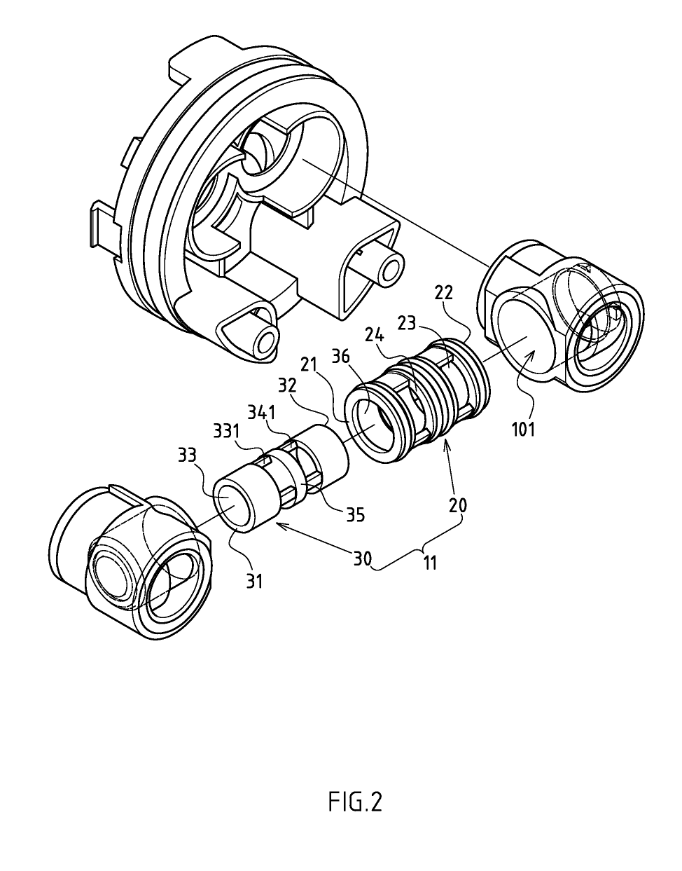

FIGS. 1-3 depict preferred embodiments of a balance control valve of the present invention with improved operational sensitivity, which, however, are provided for only explanatory objective for patent claims.

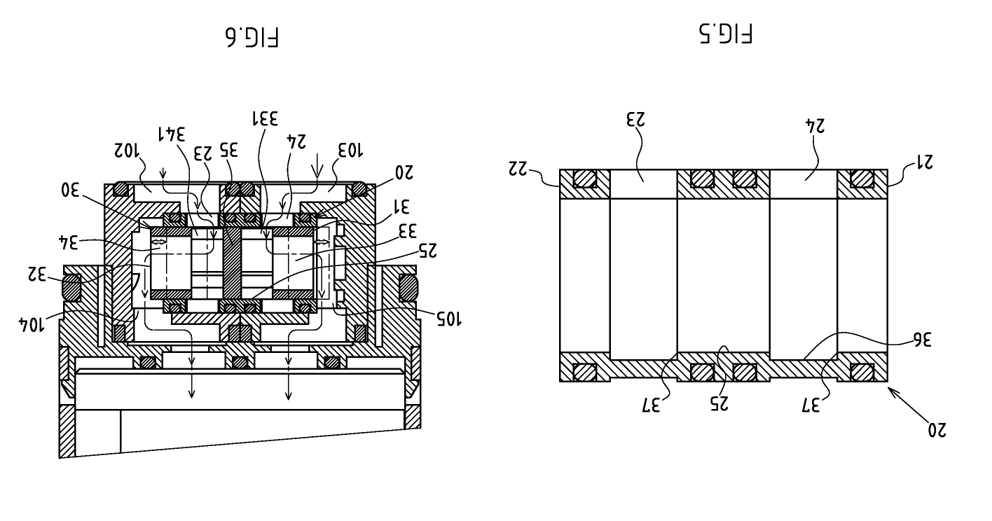

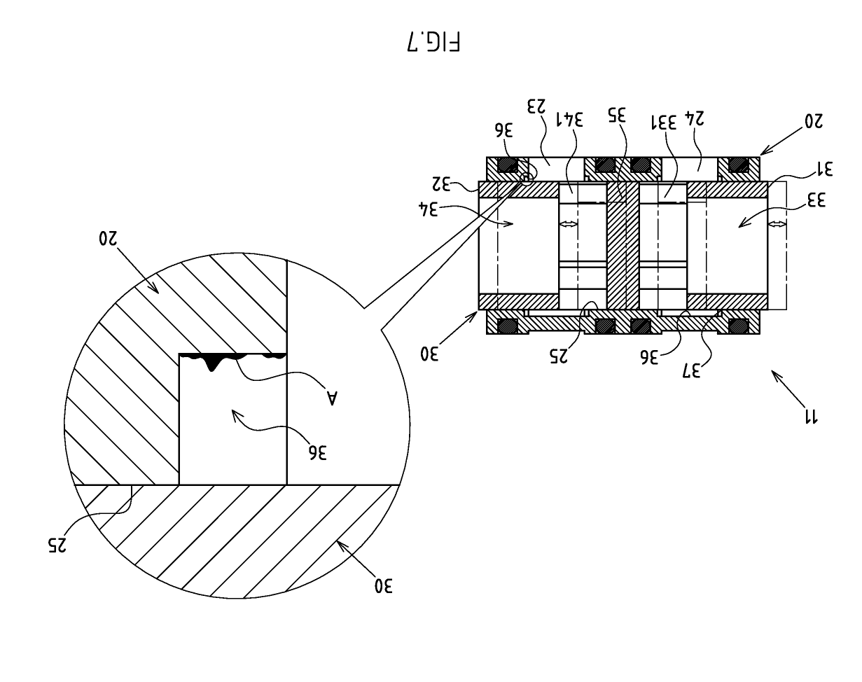

FIGS. 1-6 depict preferred embodiments of a balance control valve of the present invention with improved operational sensitivity, which, however, are provided for only explanatory objective for patent claims. Said balance control valve 11 with improved operational sensitivity is accommodated in a holding space 101 preset into the dual-temperature ceramic valve 10. The holding space 101 comprises of a cold water inlet 102 and a hot water inlet 103 arranged at interval on the bottom, as well as a cold water outlet 104 and a hot water outlet 105 arranged at interval on the top

The balance control valve 11 comprises a fixed valve pipe 20, a transverse hollow pipe, having a first port 21, a second port 22, a cold water opening 23 connected with the cold water inlet 102, and a hot water opening 24 connected with the hot water inlet 103. Moreover, the first port 21 is connected with the hot water outlet 105, and the second port 22 connected with the cold water outlet 104; an inner wall 25 is formed onto the fixed valve pipe 20.

A moveable spool 30 is transversely assembled into the inner wall 25 of the fixed valve pipe 20 in a transverse movement state. The moveable spool 30 is provided with a first end 31 and a second end 32, of which the first end 31 is recessed to form a hot water slot 33, and the second end 32 is recessed to form a cold water slot 34. The hot water slot 33 and cold water slot 34 are separated by a partition 35. Besides, the hot water slot 33 is provided with a hot water punch hole 331 connected with the hot water opening 24 of the fixed valve pipe 20, and the cold water slot 34 is provided with a cold water punch hole 341 connected with the cold water opening 23 of the fixed valve pipe 20.

At least one annular groove 36 is annularly arranged on the inner wall 25 of the fixed valve pipe 20, such that said annular groove 36 is not kept in contact with the moveable spool 30.

An unsealing portion 37 is formed between the annular grooves 36 and the inner wall 25 of the fixed valve pipe 20 in a vertical configuration, and is used to remove scale B generated on the exterior of the moveable spool 30 (see FIG. 8).

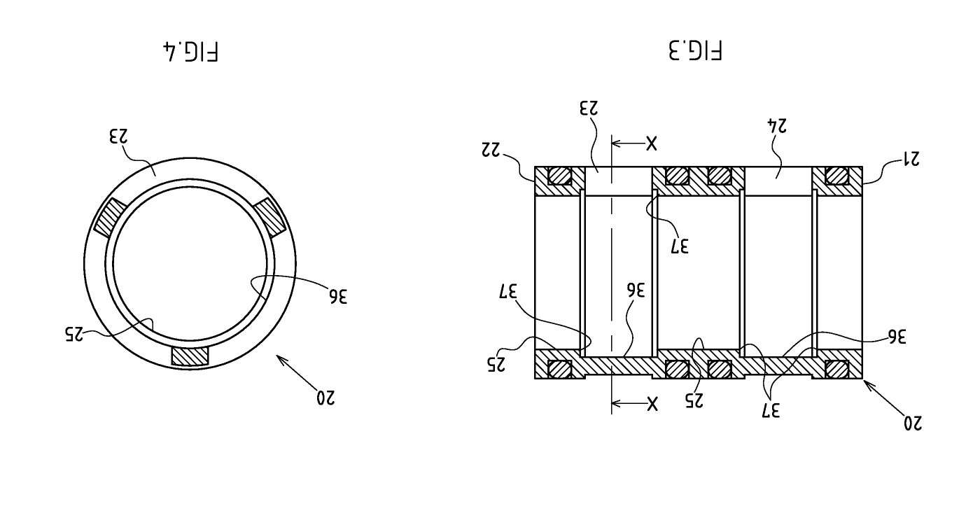

Of which, said annular grooves 36 are located correspondingly to the cold water opening 23 and hot water opening 24 of the fixed valve pipe 20, and the setting width of said annular groove 36 is equal to or bigger than the width of the cold water opening 23 and hot water opening 24 (see FIGS. 3-5).

With this design, the friction area between the moveable spool 30 and the inner wall 25 of the fixed valve pipe 20 could be reduced by said annular groove 36, so as to improve the operational sensitivity of the moveable spool 30, remove the scale and extend the service life of the balance control valve 11.

Based on above-specified structural design, the present invention is operated as follows.

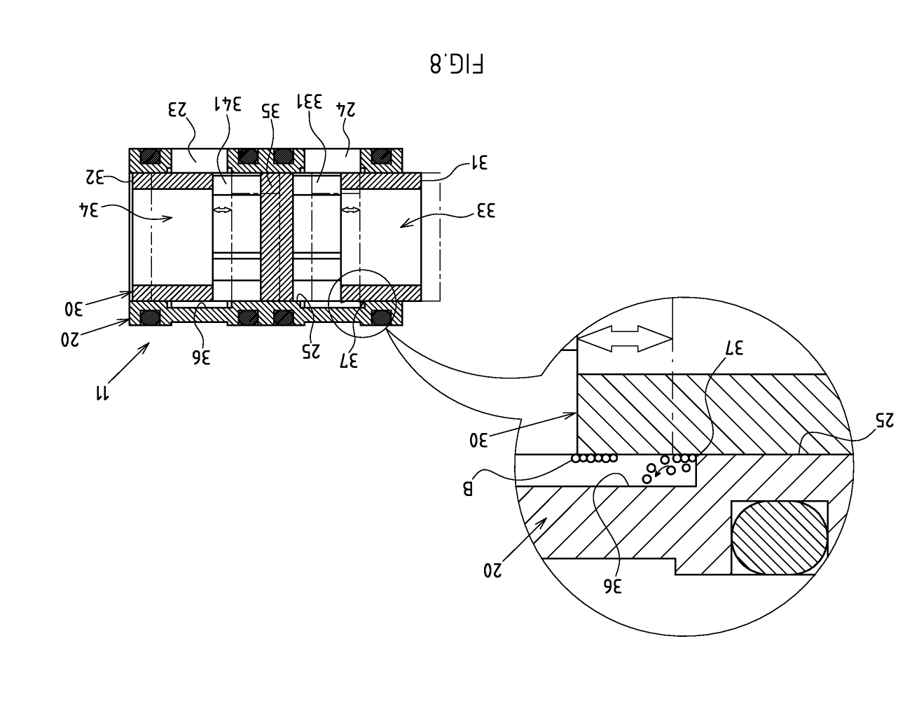

Referring to FIG. 7, in the event of reciprocating transverse movement of the moveable spool 30 in the inner wall 25 of the fixed valve pipe 20, the contact area of the moveable spool 30 and the inner wall 25 of the fixed valve pipe 20 could be reduced by the annular groove 36 recessed onto the inner wall 25, helping to improve the operational sensitivity of the moveable spool 10. Moreover, a capillary rough edge A formed internally on the cold/hot water openings 23, 24 of the fixed valve pipe 20 will be accommodated into said annular groove 36, such that the operation of the moveable spool 30 is immune to the influence of the rough edge A.

Referring to FIG. 8, during reciprocating transverse motion of the moveable spool 30 in the inner wall 25 of the fixed valve pipe 20, the vertical configuration of unsealing portion 37 formed between the annular groove 36 and the inner wall 25 of the fixed valve pipe 20 could be used to remove scale B on the exterior of the moveable spool 30, thus realizing the effect of automatically removing scale B and maintaining the smoothness of the moveable spool 30.

1. A balance control valve with improved operational sensitivity, which is accommodated in a holding space preset into the dual-temperature ceramic valve; the holding space comprising a cold water inlet and a hot water inlet arranged at interval on the bottom, as well as a cold water outlet and a hot water outlet arranged at interval on the top; the balance control valve comprising:
a fixed valve pipe, a transverse hollow pipe, comprising a first port, a second port, a cold water opening connected with the cold water inlet, and a hot water opening connected with the hot water inlet; moreover, the first port is connected with the hot water outlet, and the second port connected with the cold water outlet; an inner wall is formed onto the fixed valve pipe;
a moveable spool, transversely assembled into the inner wall of the fixed valve pipe in a transverse movement state; the moveable spool is provided with a first and a second end, of which the first end is recessed to form a hot water slot, and the second end is recessed to form to cold water slot; the hot and cold water slots are separated by a partition; besides, the hot water slot is provided with a hot water punch hole connected with the hot water opening of the fixed valve pipe, and the cold water slot is provided with a cold water punch hole connected with the cold water opening of the fixed valve pipe;
at least an annular groove, annularly arranged on the inner wall of the fixed valve pipe, such that said annular groove is not kept in contact with the moveable spool; and
an unsealing portion, formed between the annular grooves and the inner wall of the fixed valve pipe in a vertical configuration, and used to remove scale generated on the exterior of the moveable spool;
of which, said annular grooves are located correspondingly to the cold water opening and hot water opening of the fixed valve pipe, and the setting width of said annular groove is equal to or bigger than the width of the cold water opening and hot water opening; with the setting of said annular groove, the contact area of the moveable spool and the inner wall of the fixed valve pipe could be reduced so as to improve the operational sensitivity of the moveable spool, remove the scale and extend the service life of the balance control valve.
